(19) United States
(12) Patent Application Publication
(10) Pub. No.: US 2019/0256734 A1
(43) Pub. Date: Aug. 22, 2019

(54) ADHESION PROMOTER FOR COATINGS ON METAL SURFACES

(71) Applicant: Holland Novochem Technical Coatings B.V., Houten (NL)

(72) Inventors: Alexander Maslow, Deventer (NL); Erik Alexander Bijpost, Nieuwegein (NL)

(21) Appl. No.: 16/313,954

(22) PCT Filed: Jun. 29, 2017
(86) PCT No.: PCT/NL2017/000009

§ 371 Date: Dec. 28, 2018

(30) Foreign Application Priority Data
Jun. 29, 2016 (NL) 1041959
Jun. 29, 2016 (NL) 1041960
Aug. 3, 2016 (NL) 1042005

(51) Int. Cl. C09D 161/06; C08G 8/18

(52) U.S. Cl. CPC C09D 161/06; C08G 8/18

(57) ABSTRACT

Coating or resin compositions substantially free of bisphenol A with excellent surface adhesion comprising a compound in an effective amount of less than 10% w/w based on the resin with the following structure:

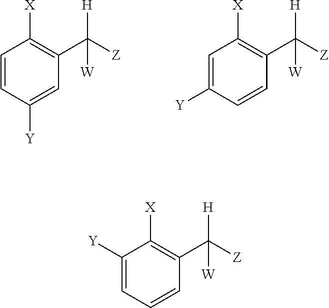

The adhesion promoters are preferably aldehyde condensation products of aromatic carboxylic acid, phosphonic acid, phosphinic acid, sulphonic acid or sulphinic acid or its corresponding ionic form.

### INTRODUCTION

Many metal objects are treated with a coating to establish an aesthetic effect, to maintain the original quality over a long period of time, to improve the performance and so on. Adhesion is a crucial factor for the success of the coating. Due to the complexity of the adhesion, especially on metal alloys, it appeared difficult to obtain robust adhesion promoting systems. Well known successful products are silanes, carboxylic acids, sulphonates and phosphates, in particular epoxy phosphate esters of bisphenol A (BPA) resins.

Those skilled-in-the-art are familiar with the high regulatory pressure on BPA as it is considered as an endocrinic disruptor. Consequently, BPA-containing compounds are about to be expelled from coatings coming into direct contact with food or beverages, for example in two- and three piece cans, starting from internal, but it is likely that the external coatings, including inks, will be demanded to be BPA-free as well.

New adhesion promoters for coatings to be applied for direct food contact have to meet the criteria for FDA and the European Food Safety Authority (EFSA). In addition, they have to comply with REACH and other regional registrations for chemical substances. Polymers, several naturally occurring products etc. have been exempted from REACH.

Apart from the regulatory aspects, adhesion of coatings on steel appears to be very difficult. Whereas commercially many adhesion promoters for aluminum are available, proven adhesion promoters for steel are very hard to find. Small variations in the steel composition can lead to substantially different bonding strengths, possibly resulting in loss of adhesion.

### INVENTION

Surprisingly, Applicant found that excellent adhesion of coating compositions can be achieved upon adding a compound comprising the following structure:

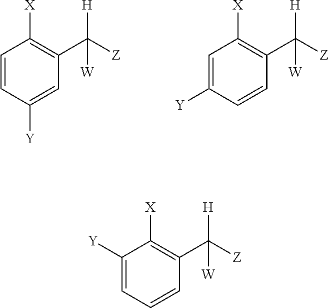

X and Y can be independently selected from hydrogen, alkyl, aryl, substituted alkyls, substituted aryls, polar functional groups, such as alcohol, mercapto, nitro, amines, primary amides, secondary amides, ketones, aldehydes, epoxy phosphate esters, sulphates, carboxylic acids, phosphonic acids, phosphinic acids, sulphonic acids and sulphinic acids. One of the substituents X or Y must be a carboxylic acid, phosphonic acid, phosphinic acid, sulphonic acid, sulphinic acid and heterocycle or its corresponding ionic form (either metal salts or neutralized with an alkaline, such as an amino compound). The substitution on the aromatic ring can be ortho, meta or para. Higher substituted benzene molecules are also available and can meet also the criteria for adhesion promotion.

W and Z can be independently selected from hydrogen, alkyl, aryl, substituted alkyls, substituted aryls, polycylic aromatics, substituted polycyclic aromatics, polar functional groups, such as alcohol, mercapto, nitro, amines, primary amides, secondary amides, ketones, aldehydes, epoxy phosphate esters, sulphates, carboxylic acids, phosphonic acids, phosphinic acids, sulphonic acids and sulphinic acids.

Next to benzene, the aromatic moiety can also be selected from naphthalene, anthracene, phenanthrene and structure homologues as well as Hückel rule aromatic compounds, possibly containing higher degree of substitution.

The present invention further pertains to a coating composition comprising a resin and an adhesion promoter of the formula:

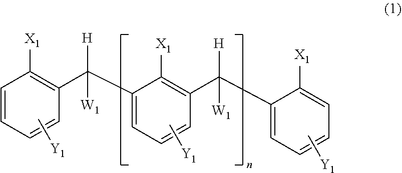

wherein n is a number from 0 to 1000, X₁ and Y₁ are independently selected from hydroxyl and polar functional groups, such as alcohol, mercapto, nitro, amines, primary amides, secondary amides, ketones, aldehydes, epoxy phosphate esters, sulphates, carboxylic acids, phosphonic acids, phosphinic acids, sulphonic acids, sulphinic acids and heterocycles.

W₁ are independently selected from hydrogen, alkyl, aryl, substituted alkyls, substituted aryls, polycylic aromatics, substituted polycyclic aromatics, polar functional groups, such as alcohol, mercapto, nitro, amines, primary amides, secondary amides, ketones, aldehydes, epoxy phosphate esters, sulphates, carboxylic acids, phosphonic acids, phosphinic acids, sulphonic acids, sulphinic acids and heterocylces; wherein at least one of X₁ and Y₁ is hydroxyl and the other group is a polar functional group. Substituent Y₁ can be in the meta, ortho or para position in relation to the X₁ substituent. In a preferred embodiment, the adhesion promoter comprises an X₁ and Y₁ selected from hydroxyl and an acid group selected from carboxylic acid, sulphonic acid, phosphonic acid. Preferably, X₁ and Y₁ are selected from hydroxyl and carboxylic acid. Even more preferably, X₁ is hydroxyl and Y₁ is an acid group, preferably carboxylic acid. In one embodiment, the molar amount of the benzylic moiety having X₁ is hydroxyl and Y₁ is an acid group is at least 50% of the total of benzylic moieties in the adhesion promoter, preferably at least 60%, more preferably at least 70%, even more preferably at least 80% and most preferably at least 90% of the total of benzylic moieties in the adhesion promoter. Preferably, the adhesion promoter comprises a condensate of salicylic acid and formaldehyde and optionally of other compounds, such as phenol and phenol-containing compounds. In one embodiment, the molar amount of salicylic acid is at least 50% of the total of benzylic moieties in the adhesion promoter, preferably at least 60%, more preferably at least 70%, even more preferably at least 80% and most preferably at least 90% of the total of benzylic moieties in the adhesion promoter. Preferably, the adhesion promoter does not comprise a benzylic compound, in particular a phenol, comprising an alkyl substituent like e.g. methyl and tert-butyl. Also adhesion promoters prepared with oligomerized or polymerized aldehyde such as paraformaldehyde having more than 8 monomeric aldehyde units are not preferred.

The adhesion promoter of the invention has a value n of from 0 to 1000. Preferably, n is at least 1, more preferably at least 2, even more preferably at least 3, even more preferably at least 4 and most preferably at least 5, and preferably at most 75, more preferably at most 50, even more preferably at most 30 and most preferably at most 20.

The adhesion promoter of the invention is generally prepared under acidic conditions and/or with a stoichiometric or below-stoichiometric amount of the formaldehyde or corresponding reactants. In this way, the adhesion promoter will generally comprise the methylene groups on the ortho position of the X or X₁ substituent rendering a promoter of the novolac type. Alternatively, the adhesion promoter can be prepared under alkaline conditions and/or with an excess of the formaldehyde or corresponding reactants. In this way, the adhesion promoter will generally comprise the methylene groups on the ortho and/or the para position of the X or X₁ substituent rendering a promoter of the resol type. Although the invention comprises both the novolac and the resol type adhesion promoter. Of these promoters the novolac type adhesion promoter is preferred.

The condensates of the novolac type that are in accordance with the invention are prepared using a benzylic compound and an aldehyde such as formaldehyde. The molar ratio of the benzylic compound to the aldehyde in this process is generally at least 1, preferably at least 1.1, more preferably at least 1.2 and most preferably at least 1.5, and generally at most 1000, preferably at most 500, more preferably at most 100, even more preferably at most 50, even more preferably at most 20 and most preferably at most 10. The same ratios apply when the benzylic compound is a combination of at least two benzylic compounds.

Typical candidates meeting these criteria are hydroxyl benzoic acids, such as salicylic acid, condensated with an aldehyde, preferably formaldehyde. These products combine the properties of both forming an ionic bonding with a metal surface, an aromatic structure for stabilization/complexation and a hydroxyl functionality to react with a cross linker, such as aminoplasts. As the molecules have a high density of active bonding sites, they show superior adhesion.

As the products according to the invention are polymers, they have been exempted from REACH regulations. Both salicylic acid and formaldehyde comply with the FDA (21CFR175.300) and EFSA (EU directive, No 10/2011) lists for direct food contact. It must be noted that formaldehyde is under suspicion, but no free formaldehyde will be present in the final cured coatings.

The adhesion promoter of the invention is generally present in the composition in an amount of at most 10 weight percent (wt %), based on the total weight of the resin. Preferably, the composition comprises at most 10 wt % of the adhesion promoter, more preferably at most 5 wt %, even more preferably at most 2 wt %, and most preferably at most 1 wt %, and preferably at least 0.01 wt %, more preferably at least 0.1 wt %, even more preferably at least 0.5 wt % and most preferably at least 1 wt % of the adhesion promoter, based on the total weight of resin.

The resin suitable for the composition of the invention can be any resin known in the art. Such resins include polyols, polyacrylates, polyesters, aminoplasts, phenoplasts, polyurethanes and alkyd resins. Other suitable resins include polyolefins such as polyethylene and polypropylene. Unsaturated polyolefins such as natural rubber are less preferred resins.

The polyol of the invention may be a monomer, an oligomer or polymer. Examples of polyols are polyols prepared from the monomeric polyols comprising hydroxyl functional groups include 1,4-butanediol, 1,3-butanediol, 1,5-pentanediol, 1,6-hexanediol, 2,5-hexanediol, 2-methyl-1,3-pentanediol, 2-ethyl-1,3-hexanediol, 2,2-dimethyl-1,3-pentanediol, 1,4-cyclohexanediol, trimethylolethane, trimethylolpropane, pentaerythritol, dipentaerythritol, 1,4-cyclohexanedimethanol, 1,2-bis(hydroxymethyl)cyclohexane, 1,2-bis(hydroxyethyl)cyclohexane, trimethylolpropane, 2,2-dimethyl-3-hydroxypropyl-2,2-dimethyl-hydroxyproprionate, diethylene glycol, triethylene glycol, dipropylene glycol, tetraethylene glycol, trimethylolethane, glycerol, and sorbitol;

Although Bisphenol containing compounds are not meeting the objective bisphenol-free, adhesion promotor compositions can be prepared based on polyols comprising oxirane functional groups bisphenol A, bisphenol F, bisphenol S, alkoxylated bisphenol A such as ethoxylated bisphenol A and propoxylated bisphenol A and alkoxylated bisphenol F such as ethoxylated bisphenol F and propoxylated bisphenol F; polyols comprising oxirane functional groups bisphenol A diglycidyl ether, 2,2′-bis(4-hydroxyphenyl)propane bis(2,3-epoxypropylether, bisphenol F diglycidyl ether, novolac glycidyl ether, ethoxylated bisphenol A and propoxylated bisphenol

Examples of suitable polyesters include Uradil SZ255 (TMP-based polyester), polyglycolide (PGA), polycaprolactone (PCL), polyhydroxyalkanoate (PHA), polyhydroxybutyrate (PHB), polyethylene adipate (PEA), polybutylene succinate (PBS), poly(3-hydroxybutyrate-co-3-hydroxyvalerate (PHBV), polyethylene terephthalate (PET), polybutylene terephthalate (PBT), polytrimethylene terephthalate (PTT), polyethylene naphthalate (PEN) and Vectran.

Examples of alkyd resins include polyesters which are modified by fatty acids or corresponding triglycerides like for example the commercially available under tradenames Uralac AN621 S-2 60 and Uralac AN637 S-2 60 (both ex DSM Resins). The alkyd resins may further be modified using phenolic resin, styrene, vinyl toluene, acrylic monomers and/or polyurethanes.

More details of suitable alkyd resins and possible modifications can be found in US 2014/0360408.

Examples of polyacrylate resins include polymers derived from one or more of acrylate, methacrylate, ethyl acrylate, 2-chloroethyl vinyl ether, 2-ethylhexyl acrylate, 2-hydroxyethyl methacrylate, butyl acrylate, butyl methacrylate, 2-hydroxypropyl methacrylate, 3-hydroxypropyl methacrylate, 2-hydroxypropyl methacrylate, 3-hydroxypropyl methacrylate, hydroxystearyl acrylate and hydroxystearyl methacrylate. Copolymers of two or more of the aforementioned resins are also contemplated as long as the resulting resin contains reactive groups as is required by the invention.

The aminoplast of the invention may be a monomer, an oligomer or polymer. Polymeric aminoplasts may include melamine resin, dicyanimide resin, glycoluril resins, urea resins and copolymers thereof. Of these polymeric aminoplasts melamine resins are preferred. Oligomeric aminoplasts include dimers, trimers and tetramers of monomeric aminoplasts. Examples of suitable monomeric aminoplasts include condensation products of an aldehyde and methylurea, glycoluril, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 2,4,6-triethyl-triamino-1,3,5-triazine, 1,3,5-triaminobenzene and melamine. Of these aminoplasts aldehyde condensation products with melamine are preferred. Suitable aldehydes include formaldehyde, acetaldehyde, crotonaldehyde, acrolein, benzaldehyde, glyoxal and furfural. Formaldehyde is the preferred aldehyde. Further modification of the aminoplasts can also be considered, including etherification with a monoalcohol, such as methanol, ethanol, propanol, butanol, pentanol, hexanol and heptanol. Examples of such aminoplasts include hexamethoxymethyl melamine (Cymel 300 and Cymel 303), butylated melamine formaldehyde resin (Cymel 1156 and Cymel 1158 and Cymel MB-14), and partially butylated, methylated melamine formaldehyde resin (Cymel 1130) and butoxylated glycoluril formaldehyde resin, such as Cymel 1170. Of these hexamethoxymethyl melamine is usually preferred owing to price and availability. Further examples of aminoplasts include derivatives of methylurea, glycoluril, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 2,4,6-triethyl-triamino-1,3,5-triazine, 1,3,5-triaminobenzene and melamine, wherein the derivative comprises functional groups selected from the group consisting of vinyl, oxetane, carboxylic acid, hydroxyl and thiol. Examples of such derivatives include derivative of glycoluril such as TA-G, TG-G, TC-G, TH-G and TS-G. The invention also contemplates using two or more of such aminoplasts. When two or more aminoplasts are present in the coating composition, the total number of first functional groups in the two or more aminoplasts is used in the calculation of the molar ratio of first and second functional groups.

Polyolefins are polymers or copolymers obtained by polymerization of at least one ethylenically unsaturated monomer. Such polymers include polyolefins and modified polyolefins, which are known to the man skilled-in-the-art. The polyolefin or modified polyolefin can be a homopolymer or a copolymer, terpolymer of grafted polymer. Unsaturated polyolefins such as natural rubber are not preferred. Examples of (modified) polyolefins include polyethylene, polypropylene, polybutylene, polystyrene, polyvinyl chloride, polyvinylidene chloride and ethylene-propylene rubber, propylene-butene copolymer, ethylene-vinyl chloride copolymer, ethylene-vinyl acetate copolymer, acrylonitrile-butadiene-styrene copolymer (ABS), acrylonitrile-acrylate-styrene copolymer (AAS), methyl methacrylate-butadiene-styrene copolymer (MBS), chlorinated polyethylene, chlorinated polypropylene, ethylene-acrylate copolymer, vinyl chloride-propylene copolymer, maleic anhydride-grafted polyolefin, maleic acid-grafted polyolefin, and mixtures thereof. Preferred polyolefins are polyethylene, polypropylene, polystyrene and polyvinyl chloride.

Suitable examples of polyethylene are high-density polyethylene (HDPE), low-density polyethylene (LDPE), straight chain low-density polyethylene, ultra-low density polyethylene and ultra-high molecular weight polyethylene. Further examples of ethylene-based copolymers include ethylene-vinyl acetate copolymer (EVA), ethylene-ethyl acetate copolymer (EEA), ethylene-methyl acrylate copolymer (EMA) and ethylene-acrylic acid copolymer (EAA).

Preferred polyolefins are polyethylene and polypropylene, which include emulsions and dispersions thereof. Such emulsions and dispersions can be water-based or solvent-based. The inhibitor of the invention can be used in both water-based and solvent-based emulsions and dispersions. Examples of such polyolefin dispersions or emulsions include Mitsui Unisol R100 G, Mitsui XPO4A, Mitsui 5300, Mitsui Chemipearl W900 and Dow Canvera 1110.

In one embodiment of the invention, the coating composition comprises the resin in an amount of at least 10% by weight (wt %), based on the total weight of the coating composition. Preferably, the resin is present in an amount of at least 25 wt %, more preferably at least 40 wt %, even more preferably at least 65 wt % and most preferably at least 70 wt %, and preferably at most 99 wt %, more preferably at most 95 wt %, even more preferably at most 90 wt % and most preferably at most 75 wt %, based on the total weight of the coating composition.

The remaining part of the coating composition may comprise other components commonly used in coating compositions. With the resin and the adhesion promoter the other components add up to 100 wt % of the total weight of the coating composition.

The coating composition of the invention may further comprise a solvent. The solvent may be any suitable solvent known in the art. Preferred solvents are reactive solvents that comprise third functional groups capable of reacting with the aminoplast and/or the first resin, preferably the polyol. The third functional groups may be hydroxyl, amine or thiol. Preferably, the third functional group is a hydroxyl or an amine. Examples of reactive solvents include alcohols, such as methanol, ethanol, diethanol, amino ethanol, glycol, n-propanol, iso-propanol and ethanethiol, ethylene glycol, propylene glycol and neopentyl glycol; and amines, such as methyl amine, ethanol amine, dimethyl amine, methyl ethanol amine, diphenyl amine, trimethyl amine, triphenyl amine and piperidine; and acrylates such as acrylate, methacrylate, ethyl acrylate, 2-chloroethyl vinyl ether, 2-ethylhexyl acrylate, 2-hydroxyethyl methacrylate, butyl acrylate, butyl methacrylate, 2-hydroxypropyl methacrylate, 3-hydroxypropyl methacrylate, 2-hydroxypropyl methacrylate, and 3-hydroxypropyl methacrylate; and water. In one embodiment of the invention, the coating composition further comprises water as solvent, possibly as the reactive solvent.

Examples of non-reactive solvents include Solvent Naphtha®, heavy benzene, various Solvesso® grades, various Shellsol® grades and Deasol®, various white spirits, mineral turpentine oil, tetralin, decalin, methyl ethyl ketone, acetone and methyl n-propyl ketone. Non-reactive solvents that are incorporated at least partially and preferably completely, into the cured resin are preferred. Preferably, the non-reactive solvent has a boiling point above the curing temperature, preferably above 250° C. The coating composition of the invention may comprise a reactive solvent and a non-reactive solvent, a combination of two or more solvents, or a combination of two or more reactive solvents. Coating compositions comprising a reactive solvent are preferred.

The coating composition of the invention may comprise the non-reactive solvent and/or the reactive solvent in an amount of at most 30% by weight (wt %), based on the total weight of the coating composition. Preferably, the non-reactive solvent and/or the reactive solvent is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the coating composition.

The coating composition may further comprise additives commonly used in coating compositions including pigments and dyes, surfactants, flow controlling agents, thixotropic agents, anti-gassing agents, ultraviolet light stabilizers, adhesion enhancing promoters, waxes, filling agents, matting agents, defoamers and curing catalysts. The additives can be any additive known in the art. Examples of pigments and dyes include metal oxides like titanium dioxide, iron oxide, zinc oxide and chromium oxide; metal hydroxides; metal sulfides, metal sulfates, metal carbonates such as calcium carbonate; carbon black, china clay, phthalo blues and greens, organo reds and other organic dyes. The coating compositions of the invention may increase the color intensity of the pigments and dyes. This may lead to a reduction in the total amount of pigment and/or dye used. Examples of ultraviolet light stabilizers include benzophenone, such as hydroxydodecyl benzophenone, 2,4-dihydroxy-3′,5′-di-t-butyl benzophenone, 2-hydroxy-4-acryloxyethoxybenzophenone and 2-hydroxy-4-methoxy-2′-carboxybenzophenone.

The coating composition of the invention may comprise the additives in an amount of at most 30% by weight (wt %), based on the total weight of the coating composition. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the coating composition.

The invention also pertains to a coated substrate comprising a substrate and a cured coating composition applied to at least part of the substrate, the coating composition being in accordance with the invention. In an embodiment of the invention the coated substrate is a food or beverage container.

The substrate of the invention can be any substrate known in the art. The substrate may be porous or non porous. Examples of suitable substrates include metals, such as aluminum, aluminum alloys, steel, steel alloys, tin, tin allows, zinc, zinc alloys, chrome and chrome alloys; glass, such as fused silica glass, aluminosilicate glass, soda-lime-silica glass, borosilicate glass and lead-oxide glass; ceramics, such as porcelain, bone china, alumina, ceria, zirconia, carbides, borides, nitrides and silicides; plastic such as functionalized polyethylene (PE), functionalized polypropylene (PP), polyethylene terephthalate (PET), polyvinyl chloride (PVC) and nylons; and wood. Preferably, the substrate is metal, in particular aluminum and steel, which as such can be pretreated or partly pretreated with ink. The adhesion promoter of the invention causes a considerably improved adhesion and a clearly improved scratch resistance when used in coatings coated on a wide variety of substrate surfaces; in particular surfaces of “difficult” substrates such as steel can be coated with good adhesion and scratch resistance properties.

In the context of the present application the term “cure” or “cured” refers to the process of hardening of the coating composition by polymerization and/or crosslinking. This curing process can be initiated by exposure to ultraviolet radiation, heat, such as by infrared radiation, by microwave radiation or by heating, e.g. in an oven, electron beams and chemical additives. The coating compositions of the invention preferably cure through exposure to ultraviolet radiation and heat, preferably through heat.

Coatings comprising an adhesion promoter according to the invention showed excellent adhesion in several 1K stoving coating systems, such as polyester/aminoplast, alkyd resin/aminoplast and polyol/aminoplast. The adhesion on steel was found to be surprisingly well.

Apart from the adhesion promotion, the compounds showed catalytic inhibition of the oxidative radical-induced degradation of polymers susceptible to oxy radical-induced attack/decomposition, e.g. polyethylene, polypropylene, home-, co- and terpolymers as well as functionalized polymers. This is in line with another invention recently filed by the Applicant, showing an inhibitor to prevent oxidative radical degradation via a benzylic hydrogen abstraction mechanism, effective in an amount of less than 1% (w/w) based on the solid weight of the total polymer resin. The inhibitor comprises a conjugated benzyl moiety, capable of forming a stable benzylic radical, which in turn can be regenerated to the original benzyl moiety. The aromatic moiety can be selected from benzene, naphthalene, anthracene or phenanthrene.

Next to adhesion promotion and catalytic inhibition of radical induced degradation, several coating compositions showed high chemical and physical resistance especially towards wet adhesion.

The invention further pertains to an adhesion promoter of formula (1):

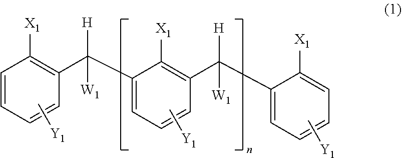

wherein n is a number from 0 to 1000, X₁ and Y₁ are independently selected from hydroxyl and polar functional groups, such as alcohol, mercapto, nitro, amines, primary amides, secondary amides, ketones, aldehydes, epoxy phosphate esters, sulphates, carboxylic acids, phosphonic acids, phosphinic acids, sulphonic acids, sulphinic acids and heterocycles; and

W₁ are independently selected from hydrogen, alkyl, aryl, substituted alkyls, substituted aryls, polycylic aromatics, substituted polycyclic aromatics, polar functional groups, such as alcohol, mercapto, nitro, amines, primary amides, secondary amides, ketones, aldehydes, epoxy phosphate esters, sulphates, carboxylic acids, phosphonic acids, phosphinic acids, sulphonic acids, sulphinic acids and heterocycles;
wherein at least one of X₁ and Y₁ is hydroxyl and the other group is a polar functional group, for use as an adhesion promoter in coating compositions comprising at most 10 wt % of the adhesion promoter, based on the total weight of resin.

The invention further pertains to the use of an adhesion promoter of formula (1):

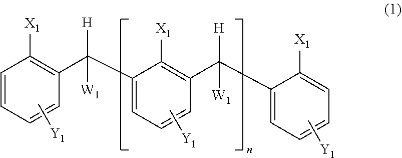

wherein n is a number from 0 to 1000, X₁ and Y₁ are independently selected from hydroxyl and polar functional groups, such as alcohol, mercapto, nitro, amines, primary amides, secondary amides, ketones, aldehydes, epoxy phosphate esters, sulphates, carboxylic acids, phosphonic acids, phosphinic acids, sulphonic acids and sulphinic acids; and

W₁ are independently selected from hydrogen, alkyl, aryl, substituted alkyls, substituted aryls, polycylic aromatics, substituted polycyclic aromatics, polar functional groups, such as alcohol, mercapto, nitro, amines, primary amides, secondary amides, ketones, aldehydes, epoxy phosphate esters, sulphates, carboxylic acids, phosphonic acids, phosphinic acids, sulphonic acids and sulphinic acids;
wherein at least one of X₁ and Y₁ is hydroxyl and the other group is a polar functional group, in coating compositions comprising at most 10 wt % of the adhesion promoter, based on the total weight of resin.

Those skilled-in-the-art understand that the polyacidic (carboxylic, sulphonic, sulphinic, phosphonic or phosphinic) products in accordance with the invention also may be applied in many other areas, such as stabilization of hardness in water treatment systems, corrosion inhibition of metals, concrete superplasticizer, chelating agent, wetting agent etc.

In a further embodiment of the invention, the coating composition of the invention can be used in application where corrosion protection and/or cured coating flexibility and formability are required. Examples of such applications include coil coating applications, car refinish, and automotive applications.

### BACKGROUND

Good adhesion is difficult to achieve. Adhesion is a surface phenomenon and is related to physical forces and chemical reactions/interactions at the interface. The highest molecular bonding strengths are primary bonds, viz. ionic (150-250 kcal/mole), covalent (15-170 kcal/mole) and metallic (27-83 kcal/mole). Secondary bonds, such as hydrogen bonds (<12 kcal/mole) and Van der Waals bonds (<10 kcal/mole) are much weaker.

Metal surfaces are usually alkaline in nature, especially in relation to active bonding sites, due to oxidation. Consequently, acidic products (low pKₐ) will show a higher reactivity on these surfaces.

One of the most powerful coating adhesion promoters to date for aluminum is an epoxy phosphate ester of bisphenol A, commercialized by DSM under the brand name Uradil DD79. Its excellent performance is assigned to the formation of strong ionic bonds (phosphate-metal), the aromatic character (stability and complexing properties) as well as the polymeric structure (introducing high molecular mass, flexibility etc.). A new adhesion promoter has to contain all these properties.

It is evident that the mechanism of adhesion under wet conditions differs from dry adhesion. It must be noted that adhesion is more critical under wet conditions: Adhesion loss is very eminent under steam condition, even more under pasteurization condition, mostly under retort sterilization condition. During retort sterilization, high pressure and high temperature steam migrates through the coating, breaking the weakest bonds at the metal-polymer surface. Epoxy phosphate ester adhesion promoters show excellent adhesion up to pasteurization conditions, yet tend to loose adhesion under retort-sterilization conditions. It is obvious that a new adhesion promoter preferably remains its function under retort-sterilization.

Recently, Applicant has reported excellent performance of coating compositions, comprising alkylated polyamine and a substituted phenol, preferably salicylic acid (WO2012/177121 and WO2012/177122). The special characteristics in terms of stability and performance are attributed by the chemical structure of salicylic acid, wherein intramolecular exchange of protons can take place in a six membered ring structure. The dry adhesion properties of these compositions were found to be excellent. However, adhesion failure has been observed under wet conditions.

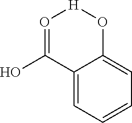

Salicylic acid can be condensated with formaldehyde in different molar ratios to form polymers in a very straightforward process (U.S. Pat. No. 4,245,083). The resulting products have been claimed to be suitable as fixing agent for dye stuffs in paper printing. These compounds as well as many similar products have been extensively studied, but have never been recognized nor reported as adhesion promoters.

Condensation products of formaldehyde and phenol sulphonic acids have been reported as well, e.g. U.S. Pat. No. 4,457,874. These compounds can be applied as dispersing agent in hydraulic cement, mortar, concrete or the like. Formaldehyde condensates of naphthalene sulphonic acids are widely applied as wetting and dispersing agent.

Phenol condensates with aldehydes have been extensively described in the literature e.g. U.S. Pat. No. 4,026,867. The resulting products are generally known as phenoplasts. In principle, each phenolic compound can be polymerized in the presence of a proper aldehyde.

Typical starting molecules which meet the criteria for adhesion promotion are salicylic acid, 3-hydroxybenzoic acid, 4-hydroxybenzoic acid, resorcylic acids (dihydroxy benzoic acids), gallic acid (trihydroxy benzoic acid), hydroxyl phthalic acids, dihydroxyl dicarboxylic benzenes, cashew nut shell liquid, aminobenzoic acid, lignosulphonates, phenol sulphonic acid, 4-hydroxyl sulphonic acid, 4-hydroxybenzylphosphonic acid, or mixtures thereof.

Apart from formaldehyde, also other aldehydes can be applied to obtain condensation products according to the invention, e.g. glyoxal (U.S. Pat. No. 6,379,800), propionaldehyde (U.S. Pat. No. 4,154,769), butyraldehyde (U.S. Pat. No. 2,176,951) or furfural (U.S. Pat. No. 2,745,816). Sometimes mixtures of aldehydes have been applied as well.

It is obvious for those skilled-in-the-art that upon varying the aromatic compounds and/or the aldehydes a wide range of molecules can be prepared, capable of promoting adhesion. The molecular weight and the amount of active bonding sites present can be also tuned by adjusting the reaction conditions, monomers or monomer mixtures selection, and molar ratios.

### EXAMPLES

### Examples 1 and 2 and Comparative Examples A and B

Formaldehyde salicylic add condensation products have been synthesized according to the procedure described in U.S. Pat. No. 4,245,083, example 1. After reaction, the polymer has been dissolved in butylglycol and neutralized with dimethylarninoethanol and diluted with water to obtain a yellow liquid, which can be handled easily

The formaldehyde salicylic acid condensate has been admixed (5% as solid on total amount of resin) with standard thermal curable coating system and tested on both aluminum and steel panels. The standard coating system contains: 10.0 g Cymel 3745, 1.0 g 1,6-hexanediol, 3.0 g butylglycol, 0.14 1-butanol and 0.03 g Cycat 500. After thermal curing (200° C., 3 minutes), cross cuts have been made in the panels and pasteurized for one hour at 90° C. Adhesion has been tested with Scotch 3M tape (ASTM D3359).

| | | | | Adhesion (0-5, |
|---|---|---|---|---|
| | | | | 0 = full |
| | | | Appearance | adhesion loss; |
| Exam- | | | after | 5 = no |
| ple | Composition | Substrate | pasteurization | adhesion loss) |
| A | Standard | Aluminum | Adhesion | Full adhesion |
| | | | loss on | loss (0) |
| | | | cross cuts | |
| B | Standard | Steel | Adhesion | Full adhesion |
| | | | loss on | loss (0) |
| | | | cross cuts | |
| 1 | Standard plus | Aluminum | No | No adhesion |
| | 5% salicylic | | blushing | loss (5) |
| | acid/formal- | | | |
| | dehyde | | | |
| | condensate | | | |
| 2 | Standard plus | Steel | No | No adhesion |
| | 5% salicylic | | blushing | loss (5) |
| | acid/formal- | | | |
| | dehyde | | | |
| | condensate | | | |

The experiments show that the components according the invention showed excellent adhesion in various concentrations on both aluminum and steel.

### Examples 3 to 13 and Comparative Example C

Aluminum cans (33cl) are treated with 40 mg XL. Black ink from INX. The treated cans were cut into pieces of 5 cm width. The can pieces are covered by a varnish by means of a spiral bar (8 micron). The varnish contains 100 g Cymel 303LF, log 1,6-hexanediol, 30 g butyl glycol, 0.20 g wetting agent, 0.60 g sulphonic acid catalyst and 10 g demineralized water. To the varnishes of the invention a compound of the invention is added in an amount of 5 wt %; the compounds are tabulated in the Table below. The compounds or condensates were prepared by thoroughly mixing the starting materials (in composition column) in a 250 ml glass flask. Subsequently, 0.5 g sulphonic acid catalyst (NaCure 155 by King Industries) was admixed. The mixture was stirred and allowed to boil for 2 hours. To some of the reaction mixtures—in cases that require water solubility—aqueous dimethylamino ethanol is added to solubilize the condensate.

| Example | | |
|---|---|---|
| C | No promoter | |
| 3 | Urad DD79 | BPA-phosphate ester |
| 4 | Condensate 1 | Salicylic Acid/formaldehyde |
| | | (97 g/69 g) |
| 5 | Condensate 2 | Salicylic Acid/formaldehyde |
| | | (245 g/46 g) |
| 6 | Condensate 3 | Salicylic Acid/4-t-butyl phenol/ |
| | | formaldehyde (12 g/12 g/46 g) |
| 7 | Condensate 4 | Salicylic Acid/4-t-butyl phenol/ |
| | | formaldehyde (5 g/19.7 g/45 g) |
| 8 | Condensate 5 | 4-Hydroxybenzoic acid/formaldehyde |
| | | (24 g/46 g) |
| 9 | Condensate 6 | 4-Hydroxybenzoic/4-t-butyl phenol/ |
| | | formaldehyde (5 g/18 g/46 g) |
| 10 | Condensate 7 | Gallic acid/formaldehyde (24 g/46 g) |
| 11 | Condensate 8 | 2-Hydroxynaphthoic acid/4-t-butyl |
| | | phenol/formaldehyde (4 g/10 g/46 g) |
| 12 | Condensate 9 | Salicylic Acid/Glyoxal (25 g/41 g) |
| 13 | Condensate 10 | Salicylic Acid/4-t-butyl phenol/ |
| | | Benzaldehyde (10 g/11 g/21 g) |

The treated aluminium pieces are cured at 190° C. in a box oven. All samples showed over 50 double MEK rubs, which means that the varnishes are fully cured. Cured aluminum pieces are subjected to pasteurization at 95° C. for 10 and 30 minutes, respectively, and evaluated on adhesion and scratch resistance. The results are shown in the Table below.

| | Adhesion | Adhesion | Adhesion | |
|---|---|---|---|---|
| | after 10 | after 30 | after 1 | Appearance |
| Exam- | min pasteur- | min pasteur- | hour pasteur- | after pasteur- |
| ple | ization | ization | ization | ization |
| C | Adhesion | Full adhesion | Full adhesion | n.d. |
| | loss | loss | loss | |
| 3 | Pass | Pass | Pass | High scratch |
| | | | | resistance |
| 4 | Pass | Pass | Pass | High scratch |
| | | | | resistance |
| 5 | Pass | Pass | Pass | High scratch |
| | | | | resistance |
| 6 | Pass | Pass | Pass | High scratch |
| | | | | resistance |
| 7 | Pass | Slight loss | Adhesion loss | High scratch |
| | | of adhesion | | resistance |
| 8 | Pass | Slight loss | Adhesion loss | High scratch |
| | | of adhesion | | resistance |
| 9 | Pass | Pass | Slight loss | High scratch |
| | | | of adhesion | resistance |
| 10 | Pass | Pass | Pass | High scratch |
| | | | | resistance |
| 11 | Pass | Full adhesion | Full adhesion | n.d. |
| | | loss | loss | |
| 12 | Pass | Pass | Very slight | High scratch |
| | | | loss of adhesion | resistance |
| 13 | Pass | Pass | Very slight | High scratch |
| | | | loss of adhesion | resistance |

All varnishes in accordance with the invention show a considerable improvement in adhesion properties and appearance compared to the varnishes of Comparative Example C. The best results are obtained with salicylic acid-containing condensates.

1. Coating or resin composition comprising a compound in an effective amount of less than 10% w/w based on the resin with the following structure: 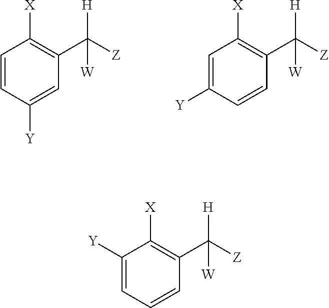
wherein X and Y are each independently selected from the group consisting of hydrogen, alkyl, aryl, substituted alkyls, substituted aryls, polar functional groups, alcohol, mercapto, amines, amides, ketones, aldehydes, carboxylic acids, phosphonic acids, phosphinic acids, sulphonic acids, sulphinic acids and heterocycles; and
wherein W and Z are each independently selected from the group consisting of hydrogen, alkyl, aryl, substituted alkyls, substituted aryls, polycylic aromatics, substituted polycyclic aromatics, polar functional groups, alcohol, amines, ketones, aldehydes, carboxylic acids, phosphonic acids, phosphinic acids, sulphonic acids, sulphinic acids and heterocycles.

2. The composition according to claim 1, wherein the aromatic moiety is selected from the group consisting of benzene, naphthalene, anthracene, phenanthrene and structure homologues.

3. The composition according to claim 1, wherein one of the substituents X or Y is selected from the group consisting of a carboxylic acid, hydroxyl group, phosphonic acid, phosphinic acid, sulphonic acid, sulphinic acid and heterocycles or their corresponding ionic form (either metal salts or neutralized with an alkaline.

4. The composition according to claim 1, wherein one of the substituents X or Y is a hydroxyl group or carboxylic acid or their corresponding ionic form.

5. The composition according to claim 1, wherein one of the substituents X or Y is a carboxylic acid or its corresponding ionic form.

6. The composition according to claim 1, wherein the aromatic moieties are linked via aldehyde condensation.

7. The composition according to claim 6, wherein the aldehyde is selected from the group consisting of formaldehyde, acetaldehyde, propionaldehyde, butyraldehyde, glyoxal and furfural.

8. The composition according to claim 6, wherein the aldehyde is condensated with one of a hydroxyl benzoic acid, dihydroxyl benzoic acid, trihydroxyl benzoic acid, hydroxyl dicarboxylic benzene and dihydroxyl dicarboxylic benzene.

9. The composition according to claim 6, wherein the aldehyde is condensated with salicylic acid.

10. The composition according to claim 1, wherein the starting materials comply with FDA (21CFR175.300) and EFSA (EU directive, No 10/2011) regulations for direct food contact.

11. The composition according to claim 1, wherein the adhesion promoter is admixed with a resin system selected from the group consisting of polyester/aminoplast resin, polyol/aminoplast resin, polyacrylate/aminoplast and alkyd resin/aminoplast.

12. The composition according to claim 1, wherein the resin mixture further comprises one or more of pigments, dyes, fillers, waxes, solvents, neutralizers, stabilizers, flow additives, slip additives, rheology improvers or mixtures thereof.

13. (canceled)

14. A method of coating a surfaces comprising:
applying a composition according to claim 1 on at least a portion of the surface; and
curing between 0 and 300° C.

15. A coating composition comprising a resin and an adhesion promoter of the formula: 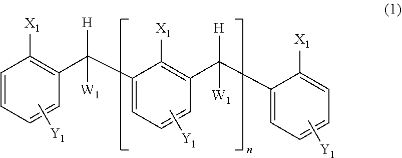
wherein n is a number from 0 to 1000;
wherein X₁ and Y₁ are each independently selected from the group consisting of hydroxyl and polar functional groups, alcohol, mercapto, nitro, amines, primary amides, secondary amides, ketones, aldehydes, epoxy phosphate esters, sulphates, carboxylic acids, phosphonic acids, phosphinic acids, sulphonic acids, sulphinic acids and heterocycles;
wherein W₁ is independently selected from the group consisting of hydrogen, alkyl, aryl, substituted alkyls, substituted aryls, polycylic aromatics, substituted polycyclic aromatics, polar functional groups, alcohol, mercapto, nitro, amines, primary amides, secondary amides, ketones, aldehydes, epoxy phosphate esters, sulphates, carboxylic acids, phosphonic acids, phosphinic acids, sulphonic acids, sulphinic acids and heterocylces; and
wherein at least one of X₁ and Y₁ is hydroxyl and the other group is a polar functional group.

16. The coating composition according to claim 15, wherein the adhesion promoter comprises a condensate of salicylic acid and formaldehyde.

17. The composition according to claim 1, wherein the composition is substantially free of bisphenol A.

18. The composition according to claim 17, wherein the composition further embodies excellent surface adhesion.

19. The composition according to claim 17, wherein the composition further embodies excellent metal surface adhesion.

20. The method according to claim 14, wherein curing occurs between 50 and 250° C.

21. The method according to claim 14, wherein curing occurs between 140 and 220° C.
